(19) United States
(12) Patent Application Publication
(10) Pub. No.: US 2016/0214367 A1
(43) Pub. Date: Jul. 28, 2016

(54) SUBSTRATE DETACHMENT APPARATUS AND METHOD FOR MANUFACTURING DISPLAY DEVICE USING THE SAME

(71) Applicant: Samsung Display Co., Ltd., Yongin-si (KR)

(72) Inventors: Hyunhwan CHOI, Daejeon (KR); Myunghwan PARK, Suwon-si (KR); Seung-Jin BAEK, Suwon-si (KR); ManHong NA, Seoul (KR); Kunhee JO, Yongin-si (KR)

(21) Appl. No.: 14/848,780

(22) Filed: Sep. 9, 2015

(30) Foreign Application Priority Data
Jan. 23, 2015 (KR) 10-2015-0011526

(51) Int. Cl. B32B 43/00; G02F 1/13

(52) U.S. Cl. CPC B32B 43/006; G02F 1/1303

(57) ABSTRACT

Provided is a substrate detachment apparatus including a plurality of stepped substrates having a stair shape, each of which includes at least one or more stepped layers, the plurality of stepped substrates partially overlapping each other, a plurality of vacuum generating members coupled to holes formed in each of the stepped substrates, and a plurality of vacuum adsorption pads connected to the vacuum generating members, the plurality of vacuum adsorption pads being adsorbed to a substrate, wherein the stepped substrates vertically ascends in sequence inward from a stepped substrate connected to a plurality of vacuum adsorption pads, which are adsorbed to a outermost side of the substrate, of the vacuum adsorption pads.

### CLAIM OF PRIORITY

This U.S. non-provisional patent application claims the priority of and all the benefits accruing under 35 U.S.C. §119 of Korean Patent Application No. 10-2015-0011526, filed on Jan. 23, 2015 in the Korean Intellectual Property Office (KIPO), the entire contents of which are hereby incorporated by reference.

### BACKGROUND OF THE INVENTION

1. Field of Disclosure

Embodiments of the present invention relate to a liquid crystal display device capable of properly controlling movement of liquid crystal molecules disposed adjacent to a border area between domains and to a method of manufacturing the liquid crystal display device.

2. Description of the Related Art

The present disclosure herein relates to a substrate detachment apparatus, and more particularly, to a method for manufacturing a display device by using a substrate detachment apparatus.

Display devices having large-size, flat-surface, and various functions fulfill the demand in image industries of the modern information-oriented society. Also, display devices that are easily portable and lightweight fulfill the demand to freely record and exchange information anytime. However, a glass substrate used for existing display devices has a predetermined thickness and is fragile and inflexible due to the characteristics of glass. Accordingly, flexible substrates having a flexible characteristic are being developed in recent years to overcome these disadvantages.

Flexible substrates such as plastic or metal foils are used to realize flexible display devices. Such a flexible substrate may not be suitable for an existing process because of flexibility that is a characteristic different from that of the hard glass substrate for the existing display devices. That is, the flexible characteristic may cause a difficulty in pattern alignment when a pattern (e.g., a thin film transistor having a laminated structure and a plurality of lines) is formed on a substrate. Thus, transfer technologies that are capable of transferring a flexible substrate or a process performed on the flexible substrate in a state where the flexible substrate is adhered to a hard material such as a glass substrate are being suggested.

Also, detachment technologies for detaching the flexible substrate from the glass substrate after a pattern process are needed. For example, a substrate detachment apparatus includes a plurality of vacuum adsorption pads which are adsorbed onto the glass substrate attached to the flexible substrate. The substrate detachment apparatus separates the flexible substrate from the glass substrate by using the vacuum adsorption pads. In this case, however, an initial adsorption portion and a final adsorption portion of the glass substrate may be damaged due to a difference in adsorption force between the adsorption pads.

### SUMMARY OF THE INVENTION

The present disclosure provides a substrate detachment apparatus for detaching an auxiliary substrate from a panel substrate by using a plurality of stepped substrates having a stair shape and a method for manufacturing a display device by using the same.

Embodiments of the inventive concept provide substrate detachment apparatuses including a plurality of stepped substrates having a stair shape, each of which includes at least one or more stepped layers, the plurality of stepped substrates partially overlapping each other; a plurality of vacuum generating members coupled to holes formed in each of the stepped substrates; and a plurality of vacuum adsorption pads connected to the vacuum generating members, the plurality of vacuum adsorption pads being adsorbed to a substrate, wherein the stepped substrates vertically ascends in sequence inward from a stepped substrate connected to a plurality of vacuum adsorption pads, which are adsorbed to a outermost side of the substrate, of the vacuum adsorption pads.

In some embodiments, the substrate detachment apparatus may further include a plurality of suction devices respectively connected to the vacuum generating members to vertically lift the stepped substrates.

In other embodiments, each of the stepped substrates may include a first stepped layer extending in a horizontal direction; a second stepped layer overlapping one region that is defined above the first stepped layer to form the stair shape together with the first stepped layer; and a third stepped layer overlapping one region that is defined above the second stepped layer to form the stair shape together with the second stepped layer.

In still other embodiments, each of the stepped substrates may include a first stepped layer extending in a horizontal direction; a second stepped layer overlapping one region that is defined above the first stepped layer to form the stair shape together with the first stepped layer; and a third stepped layer overlapping one region that is defined above the second stepped layer to form the stair shape together with the second stepped layer.

In even other embodiments, the holes, to which the vacuum generating members are coupled, may be defined in the second stepped layer.

In yet other embodiments, in two first and second stepped substrates adjacent to each other of the stepped substrates, one region of the third stepped layer of the first stepped substrate and one region of the first stepped layer of the second stepped substrate may overlap each other with a predetermined gap therebetween.

In further embodiments, the second stepped substrate may be disposed further outside than the first stepped substrate.

In still further embodiments, after the second stepped substrate vertically ascends, the first stepped substrate may vertically ascend.

In even further embodiments, when the second stepped substrate vertically ascends, the first stepped layer of the second stepped substrate may be in contact with and coupled to the third stepped layer of the first stepped substrate.

In yet further embodiments, the second stepped layers of each of the stepped substrates may have heights corresponding to positions parallel to each other.

In much further embodiments, the second stepped layer may have an extension length longer than that of the first or third stepped layer.

In other embodiments of the inventive concept, methods for manufacturing a display apparatus include providing an auxiliary substrate and a panel substrate; attaching the auxiliary substrate to the panel substrate; performing a process of manufacturing the display panel on the panel substrate; and separating the auxiliary substrate from the panel substrate, wherein the separating of the auxiliary substrate includes providing a plurality of stepped substrates having a stair shape, each of which includes at least one or more stepped layers, and partially overlapping each other, coupling a plurality of vacuum generating members to holes formed on each of the stepped substrates; connecting the plurality of vacuum adsorption pads to the vacuum generating members; adsorbing the vacuum adsorption pads onto the auxiliary substrate; and vertically lifting the stepped substrates in sequence inward from the stepped substrate coupled to the vacuum adsorption pads, which are adsorbed to the outermost substrate auxiliary substrate of the vacuum adsorption pads.

In some embodiments, the method may further include connecting a plurality of suction devices to the vacuum generating members, wherein the suction devices vertically lift the stepped substrates in sequence inward from the outermost substrate.

In other embodiments, each of the stepped substrates may include: a first stepped layer extending in a horizontal direction; a second stepped layer overlapping one region that is defined above the first stepped layer to form the stair shape together with the first stepped layer; and a third stepped layer overlapping one region that is defined above the second stepped layer to form the stair shape together with the second stepped layer.

In still other embodiments, in two first and second stepped substrates adjacent to each other of the stepped substrates, one region of the third stepped layer of the first stepped substrate and one region of the first stepped layer of the second stepped substrate may overlap each other with a predetermined gap therebetween.

In even other embodiments, the second stepped substrate may be disposed further outside than the first stepped substrate.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view of a panel substrate and an auxiliary substrate;

FIG. 2 is a perspective view of a substrate detachment apparatus disposed on the auxiliary substrate and the panel substrate according to an embodiment of the inventive concept;

FIG. 3 is a cross-sectional view taken along line I-I′ of FIG. 2;

FIG. 4 is a view illustrating a structure of stepped substrates, taken along line I-I′ of FIG. 3; and

FIGS. 5 to 8 are views illustrating a process of detaching the auxiliary substrate from the panel substrate.

FIG. 9 is a cross-sectional view showing a process of detaching the auxiliary substrate from the panel substrate symmetrically on both sides of a center of the substrate detachment apparatus in FIG. 2.

FIG. 10 is a cross-sectional view showing a process of detaching the auxiliary substrate from the panel substrate non-symmetrically on both sides of a center of the substrate detachment apparatus in FIG. 2.

### DETAILED DESCRIPTION OF THE INVENTION

Hereinafter, specific embodiments will be described in detail with reference to the accompanying drawings. The present invention may, however, be embodied in different forms and various modifications and variations can be made in the present invention. The present invention should not be construed as being limited to the embodiments set forth herein and should be understood to be intended to include the structural and functional equivalents of the matter.

Like reference numerals refer to like elements throughout. In the figures, the dimensions of layers and regions are exaggerated for clarity of illustration. It will be understood that although the terms first and second are used herein to describe various elements, these elements should not be limited by these terms. These terms are used only to differentiate one component from another one. For example, without departing from the scope of the present invention, a first element could be termed a second element, and similarly a second element could be termed a first element. The terms of a singular form may include plural forms unless referred to the contrary.

The meaning of “include,” “comprise,” “including,” or “comprising,” specifies features, integers, steps, operations, elements, components or combinations thereof listed in the specification but does not exclude other features, integers, steps, operations, elements, components or combinations thereof.

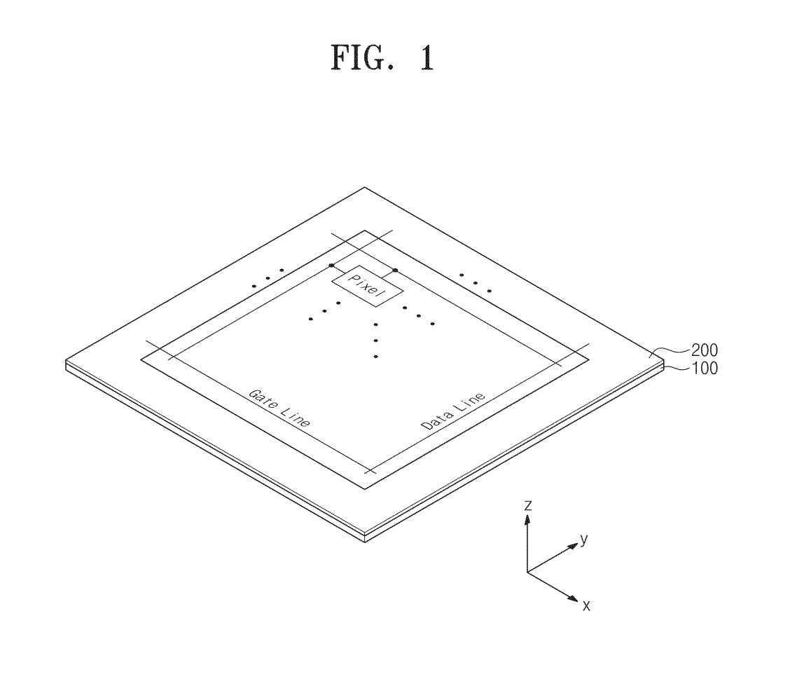

FIG. 1 is a perspective view of a panel substrate and an auxiliary substrate.

Referring to FIG. 1, an auxiliary substrate 100 may be a glass substrate. The auxiliary substrate 100 may be disposed below a panel substrate 200 to support the panel substrate 200.

Although the auxiliary substrate 100 has the same size as the panel substrate 200 in FIG. 1, the auxiliary substrate may have a size greater or less than that of the panel substrate 200.

The panel substrate 200 may be disposed on the auxiliary substrate 100. A plurality of gate lines and data lines for displaying an image may be disposed on the panel substrate 200. The gate lines and the data lines are disposed on layers different from each other and electrically intersected and insulated with respect to each other. Also, a plurality of pixels connected to the gate lines and the data lines may be disposed on the panel substrate 200. In this case, a thin film process for disposing the pixels on the panel substrate 200 may be performed. When the thin film process is performed, the auxiliary substrate 100 fixedly supports the panel substrate 200.

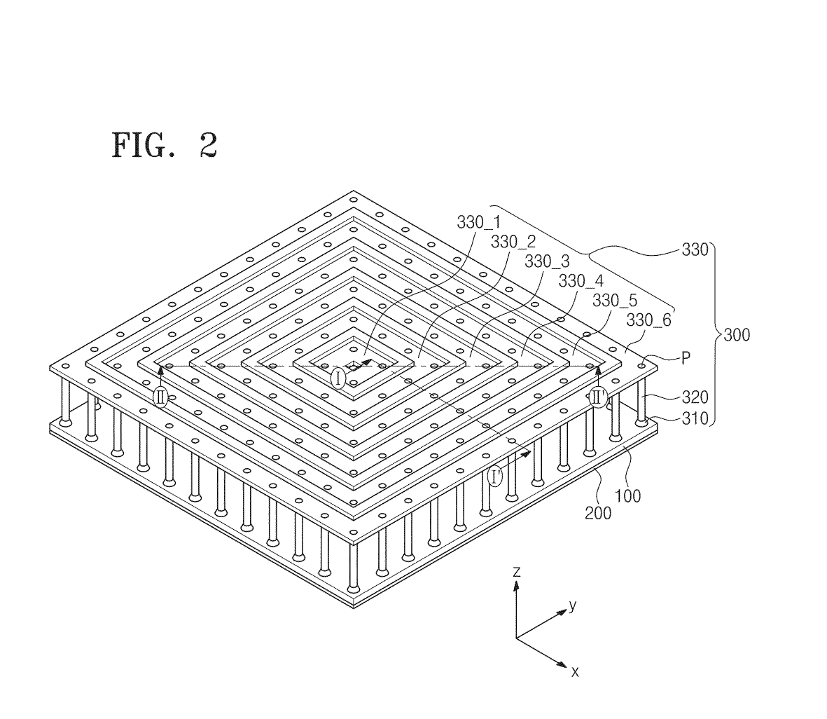

After the above-described thin film process on the panel substrate 200 is completed, a process of separating the auxiliary substrate 100 from the panel substrate 200 is performed. In this case, a substrate detachment apparatus 300 (see FIG. 2) may be used to separate the auxiliary substrate 100 from the panel substrate 200.

FIG. 2 is a perspective view of the substrate detachment apparatus 300 disposed on the auxiliary substrate and the panel substrate according to an embodiment of the inventive concept.

Referring to FIG. 2, in comparison with FIG. 1, it is illustrated that the auxiliary substrate 100 and the panel substrate 200 are inverted in sequence. That is, the auxiliary substrate 100 is disposed above the panel substrate 200.

The substrate detachment apparatus 300 may be disposed above the auxiliary substrate 100 to detach the auxiliary substrate 100 from the panel substrate 200. In detail, the substrate detachment apparatus 300 include a plurality of vacuum adsorption pads 310, a plurality of vacuum generating members 320, and a coupled substrate 330.

The vacuum adsorption pads 310 may be adsorbed onto the auxiliary substrate 100. The vacuum adsorption pads 310 may be disposed to be spaced a predetermined distance from each other on the auxiliary substrate 100. Also, each of the vacuum adsorption pads may have one end attached to the auxiliary substrate 100 and the other end coupled to each of the vacuum generating members 320. These vacuum adsorption pads 310 may detach the auxiliary substrate 100 from the panel substrate 200 by an external adsorption pressure. When the auxiliary substrate 100 is vertically lifted by the vacuum adsorption pads 310, the panel substrate 200 may be maintained in the fixed state by an external factor.

The vacuum generating members 320 may be coupled to the vacuum adsorption pads 310 and disposed below the coupled substrate 330. The number of vacuum generating members 320 may be provided with the same number of vacuum adsorption pads 310. According to an embodiment, each of the vacuum generating members 320 may have one end coupled to each of the vacuum adsorption pads 310 and the other end coupled to the coupled substrate 330. The vacuum generating members 320 may be coupled to the vacuum adsorption pads 310 to support the coupled substrate 330.

The coupled substrate 330 may include a plurality of first to sixth stepped substrates 330_1 to 330_6. According to an embodiment, the first to sixth stepped substrates 330_1 to 330_6 may have a portion separated from each other. Also, each of the first to sixth stepped substrates 330_1 to 330_6 may have at least one or more stepped layers. That is, each of the stepped substrates according to an embodiment of the inventive concept may be realized in a stair shape. Hereinafter, the first to sixth stepped substrates 330_1 to 330_6, each of which including three stepped layers, will be described as an example.

In detail, the first stepped substrates 330_1 may be disposed around a central point of the coupled substrate 330. In this case, the first stepped substrates 330_1 may have an outer end that is disposed above the second stepped substrate 330_2 to overlap the second stepped substrate 330_2. Here, the outer end may be one region of the highest stepped layer of the stepped substrates.

The second stepped substrate 330_2 may surround the first stepped substrates 330_1. In this case, the second stepped substrates 330_2 may have an inner end that is disposed below the first stepped substrate 330_1 to overlap the first stepped substrate 330_1. Here, the inner end may be one region of the lowest stepped layer of stepped layers of the stepped substrates. Also, the second stepped substrates 330_2 may have an outer end disposed above the third stepped substrate 330_3 to overlap the third stepped substrate 330_3.

The third stepped substrate 330_3 may surround the second stepped substrates 330_2. In this case, the third stepped substrates 330_3 may have an inner end that is disposed below the second stepped substrate 330_2 to overlap the second stepped substrate 330_2. Also, the third stepped substrates 330_3 may have an outer end disposed above the fourth stepped substrate 330_4 to overlap the fourth stepped substrate 330_4.

The fourth stepped substrate 330_4 may surround the third stepped substrates 330_3. In this case, the fourth stepped substrates 330_4 may have an inner end that is disposed below the third stepped substrate 330_3 to overlap the third stepped substrate 330_3. Also, the fourth stepped substrates 330_4 may have an outer end disposed above the fifth stepped substrate 330_5 to overlap the fifth stepped substrate 330_5.

The fifth stepped substrate 330_5 may surround the fourth stepped substrates 330_4. In this case, the fifth stepped substrates 330_5 may have an inner end that is disposed below the fourth stepped substrate 330_4 to overlap the fourth stepped substrate 330_4. Also, the fifth stepped substrates 330_5 may have an outer end disposed above the sixth stepped substrate 330_6 to overlap the sixth stepped substrate 330_6.

The sixth stepped substrate 330_6 may surround the fifth stepped substrates 330_5. In this case, the sixth stepped substrates 330_6 may have an inner end disposed below the fifth stepped substrate 330_5 to overlap the fifth stepped substrate 330_5.

Although the coupled substrate 330 includes the first to sixth stepped substrates 330_1 to 330_6 in an embodiment of the inventive concept, the present disclosure is not limited thereto. That is, the coupled substrate 330 may include at least one or more stepped substrates.

Also, each of the first to sixth stepped substrates 330_1 to 330_6 may have a plurality of holes P to which the vacuum generating members 320 are coupled. The plurality of vacuum generating members 320 may be coupled to the holes P formed in each of the first to sixth stepped substrates 330_1 to 330_6. Also, a suction device (not shown) may be disposed on each of the holes P formed in the first to sixth stepped substrates 330_1 to 330_6. The suction device may be coupled to the vacuum generating member 320 that is coupled to each hole P to perform a suction operation for separating the auxiliary substrate 100 from the panel substrate 200.

Also, according to the present invention, the auxiliary substrate 100 is described as a square. But, the auxiliary substrate 100 may be implemented in a rectangle or a circle.

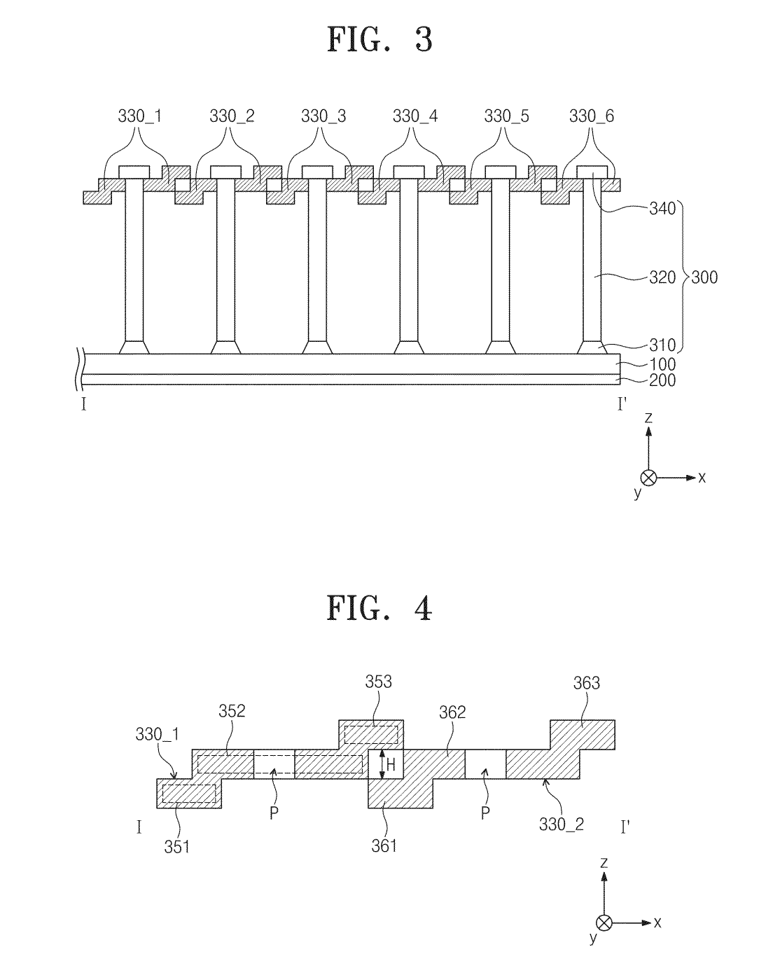

FIG. 3 is a cross-sectional view taken along line I-I′ of FIG. 2. FIG. 4 is a view illustrating a structure of the stepped substrates, taken along line I-I′ of FIG. 3.

Referring to FIG. 3, constitutions of the panel substrate 200, the auxiliary substrate 100, the vacuum adsorption pads 310, and the vacuum generating members 320 are the same as described in FIG. 2. Thus, their description will be omitted below. The coupled substrate 330 may include the first to sixth stepped substrates 330_1 to 330_6. The vacuum generating members 320 may be coupled to the holes P (see FIG. 2) formed in the first to sixth stepped substrates 330_1 to 330_6, respectively.

Also, a plurality of suction devices 340 may be disposed above the first to sixth stepped substrates 330_1 to 330_6. According to an embodiment, the suction devices 340 may be provided with numbers corresponding to the number of vacuum generating members 320. That is, one suction device may be attached to one vacuum generating member. As the vacuum adsorption pads 310 perform an adsorption operation by these suction devices 340, the auxiliary substrate 100 may be separated from the panel substrate 200.

Also, for example, the panel substrate 200 may be fixed by a clamping or fixing frame.

FIG. 4 illustrates a coupled structure between two stepped substrates adjacent to each other of the first to sixth stepped substrates 330_1 to 330_6 illustrated in FIG. 3. Hereinafter, the two stepped substrates illustrated in FIG. 4 will be described as an inner stepped substrate 350 and an outer stepped substrate 360, respectively. Also, a structure between the plurality of stepped substrates may be described on the basis of the coupled structure between the inner and outer stepped substrates 350 and 360 illustrated in FIG. 4.

The inner stepped substrate 350 includes first to third inner stepped layers 351 to 353. In detail, the first inner stepped layer 351 is disposed below the second inner stepped layer 352, and the second inner stepped layer 352 is disposed below the third inner stepped layer 353. That is, the first to third inner stepped layers 351 to 353 may form a stair shape, the layers having heights different from each other.

In detail, the second inner stepped layer 352 may horizontally extend longer than each of the first and third inner stepped layers 351 and 353. The second inner stepped layer 352 has a region in which the second inner stepped layer 352 is disposed above the first inner stepped layer 351 to overlap the first inner stepped layer 351 and a region in which the second inner stepped layer 352 is disposed below the third inner stepped layer 353 to overlap the third inner stepped layer 353. Also, a hole P region to which the vacuum generating member is coupled may be defined in a center of the second inner stepped layer 352. The third inner stepped layer 353 has a region in which the third inner stepped layer 353 is disposed above the second inner stepped layer 352 to overlap the second inner stepped layer 352. Also, the third inner stepped layer 353 has a region in which the third inner stepped layer 353 is disposed above the first outer stepped layer 361 of the outer stepped substrate to overlap the first outer stepped layer 361.

The outer stepped substrate includes first to third outer stepped layers 361 to 363. In detail, the first outer stepped layer 361 is disposed below the second outer stepped layer 362, and the second outer stepped layer 362 is disposed below the third outer stepped layer 363. That is, the first to third outer stepped layers 361 to 363 may have a stair shape having heights different from with respect to a reference bottom surface.

According to an embodiment, the first inner stepped layer 351 and the first outer stepped layer 361 may have the same height. The second inner stepped layer 352 and the second outer stepped layer 362 may have the same height. The third inner stepped layer 353 and the third outer stepped layer 363 may have the same height.

In detail, the first outer stepped layer 361 has a region in which first outer stepped layer 361 overlaps the third inner stepped layer 353 and a region in which first outer stepped layer 361 overlap the second outer stepped layer 362. Here, a stepped gap corresponding to a height of the second inner or outer stepped layer may be formed between the first outer stepped layer 361 and the third inner stepped layer 353.

The second outer stepped layer 362 may horizontally extend longer than each of the first and third outer stepped layers 361 and 363. The second outer stepped layer 362 has a region in which second outer stepped layer 362 is disposed above the first outer stepped layer 361 to overlap the first outer stepped layer 361 and a region in which the second outer stepped layer 362 is disposed below the third outer stepped layer 363 to overlap the third outer stepped layer 363. Also, a hole P region to which the vacuum member is coupled may be defined in a center of the second outer stepped layer 362.

The third outer stepped layer 363 may overlap an upper overlapping region of the second outer stepped layer 362 and the next stepped substrate adjacent thereto.

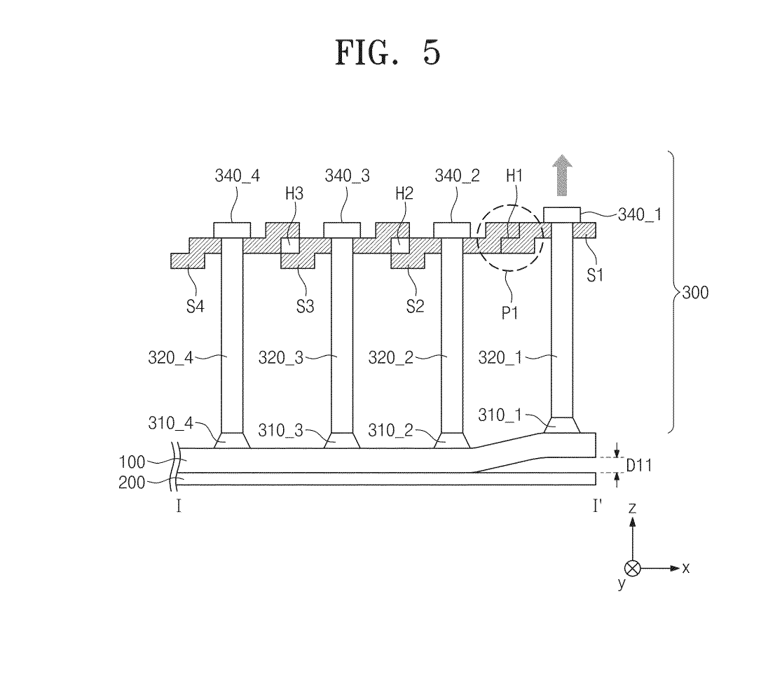

As described above, each of the stepped substrates included in the coupled substrate 330 may have three stepped layers. Particularly, two stepped substrates adjacent to each other may be coupled to each other in a region overlapping each other. This will be described in detail with reference to FIGS. 5 to 8.

FIGS. 5 to 8 are views illustrating a process of detaching the auxiliary substrate from the panel substrate.

FIGS. 5 to 8 illustrate cross-sectional views of four stepped substrates adjacent to each other of the first to sixth stepped substrates 330_1 to 330_6 illustrated in FIG. 2. Hereinafter, a process of detaching the auxiliary substrate 100 from the panel substrate 200 by the first to fourth stepped substrates S1 to S4 will be described.

The first stepped substrate S1 is disposed further outside than the second stepped substrate S2 from a center of the coupled substrate 330 (see FIG. 2). The second stepped substrate S2 is disposed further outside than the third stepped substrate S3 from the center of the coupled substrate 330. The third stepped substrate S3 is disposed further outside than the fourth stepped substrate S4 from the center of the coupled substrate 330.

The first stepped substrate Si may include stepped layers having a number less than that of the second to fourth stepped substrates S2 to S4. For example, the first stepped substrate Si may include two stepped layers, and the second to fourth stepped substrates S2 to S4 may include three stepped substrates. This is done because a stepped substrate overlapping the outside of the first stepped substrate S1 does not exist as the first stepped substrate S1 is disposed at the outermost portion from the center of the coupled substrate 330. However, the number of stepped layers of the first stepped substrate S1 which is disposed at the outermost portion is not limited to the above-described number.

Also, the first vacuum generating member 320_1 coupled to the first stepped substrate S1 may be coupled to a first vacuum adsorption pad 310_1 and a first suction device 340_1. The second vacuum generating member 320_2 coupled to the second stepped substrate S2 may be coupled to a second vacuum adsorption pad 310_2 and a second suction device 340_2. The third vacuum generating member 320_3 coupled to the third stepped substrate S3 may be coupled to a third vacuum adsorption pad 310_3 and a third suction device 340_3. The fourth vacuum generating member 320_4 coupled to the fourth stepped substrate S4 may be coupled to a fourth vacuum adsorption pad 310_4 and a fourth suction device 340_4.

According to an embodiment of the inventive concept, the first to fourth adsorption devices 340_1 to 340_4 may not operate at the same time, but sequentially operate from the outermost suction device. For example, after the outermost first suction device 340_1 operates, the second suction device 340_2 may operate.

In detail, the first suction device 340_1 disposed at the outermost portion from the center of the coupled substrate 330 may vertically ascend. As a result, a first coupled region P1 where the first stepped substrate S1 and the second stepped substrate S2 are coupled to each other may be formed. The first coupled region P1 may be formed by coupling the first and second stepped substrates S1 and S2, which are spaced apart from each other with a first gap H1 therebetween, to each other. That is, when the first suction device 340_1 vertically ascends, one end of the lowermost layer of the first stepped substrate S1 may contact one end of the uppermost layer of the second stepped substrate S2 to form the first coupled region P1.

Also, when the first suction device 340_1 vertically ascends, the auxiliary substrate 100 may be detached from the panel substrate 200 by the first vacuum adsorption pad 310_1. In this case, a region of the auxiliary substrate 100, which corresponds to a lower side of the first vacuum adsorption pad 310_1, may be detached by a first detachment height D11 from the panel substrate 200.

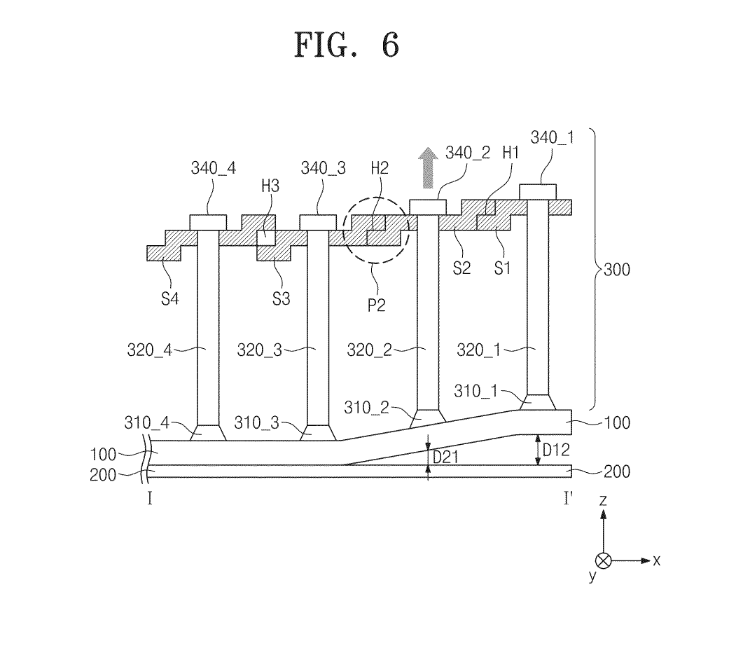

Then, referring to FIG. 6, the second suction device 340_2 may vertically ascend. As a result, a second coupled region P2 where the second stepped substrate S2 and the third stepped substrate S3 are coupled to each other may be formed. The second coupled region P2 may be formed by coupling the second and third stepped substrates S2 and S3, which are spaced apart from each other with a second gap H2 therebetween, to each other. That is, when the second suction device 340_2 vertically ascends, one end of the lowermost layer of the second stepped substrate S2 may contact one end of the uppermost of the third stepped substrate S3 to form the second coupled region P2. The first coupled region P1 where the first and second stepped substrates S1 and S2 are coupled to each other may be continuously maintained in the coupled state therebetween.

Also, when the second suction device 340_2 vertically ascends, the auxiliary substrate 100 may be more detached from the panel substrate 200 by the second vacuum adsorption pad 310_2. In this case, a region of the auxiliary substrate 100, which corresponds to a lower side of the second vacuum adsorption pad 310_2, may be detached by a second detachment height D21 from the panel substrate 200. The region of the auxiliary substrate 100, which corresponds to a lower side of the first vacuum adsorption pad 310_1, may be detached by a first detachment height D12 that is longer than the existing first detachment height D11. Here, the first detachment height D12 may be longer than the second detachment height D21.

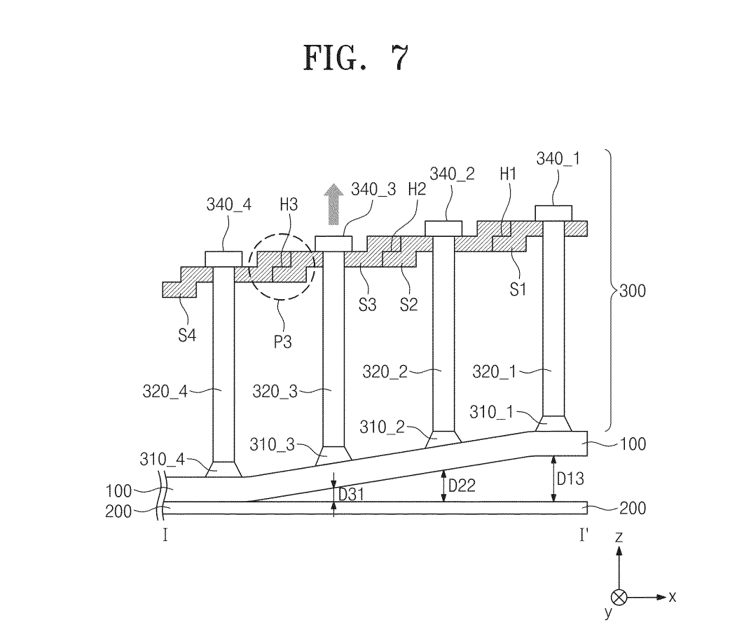

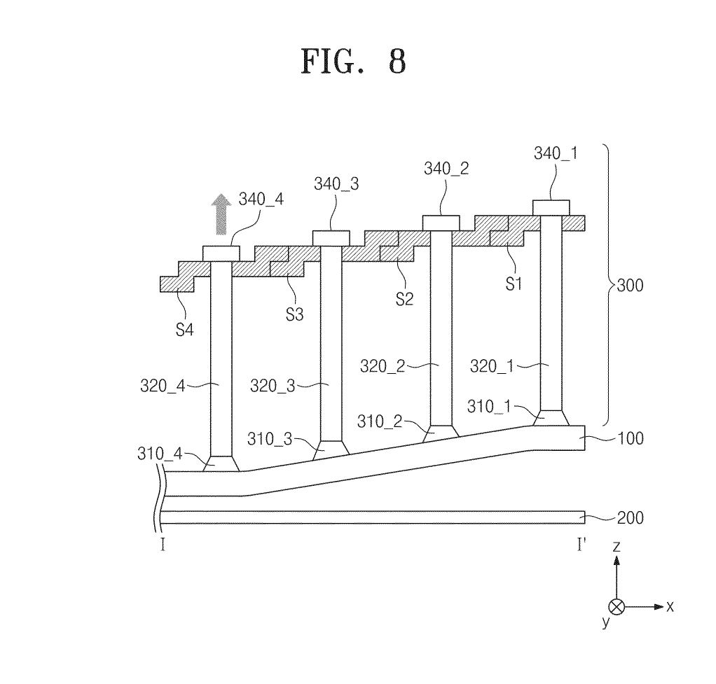

Then, referring to FIG. 7, the third adsorption device 340_3 may vertically ascend. As a result, a third coupled region P3 where the third stepped substrate S3 and the fourth stepped substrate S4 are coupled to each other may be formed. The third coupled region P3 may be formed by coupling the third and fourth stepped substrates S3 and S4, which are spaced apart from each other with a third gap H3 therebetween, to each other. That is, when the third suction device 340_3 vertically ascends one end of the lowermost layer of the second stepped substrate S2 may contact one end of the uppermost layer of the third stepped substrate S3 to form the second coupled region P2. The first coupled region P1 where the first and second stepped substrates S1 and S2 are coupled to each other and the second coupled region P2 where the second and third stepped substrates S2 and S3 are coupled to each other may be continuously maintained in the coupled state therebetween.

Also, when the third suction device 340_3 vertically ascends, the auxiliary substrate 100 may be more detached from the panel substrate 200 by the third vacuum adsorption pad 310_3. In this case, a region of the auxiliary substrate 100, which corresponds to a lower side of the first vacuum adsorption pad 301_1, may be detached by a third detachment height D31 from the panel substrate 200. The region of the auxiliary substrate 100, which corresponds to a lower side of the second vacuum adsorption pad 310_2, may be detached by a second detachment height D22 that is longer than the existing second detachment height D21. The region of the auxiliary substrate 100, which corresponds to a lower side of the first vacuum adsorption pad 301_1, may be detached by a first detachment height D13 that is longer than the existing first detachment height D12. Here, the first detachment height D13 may be longer than the second detachment height D22, and the second detachment height D22 may be longer than the third detachment height D31.

Then, referring to FIG. 8, the fourth suction device 340_4 may vertically ascend. In this case, the first coupled region P1 where the first and second stepped substrates S1 and S2 are coupled to each other, the second coupled region P2 where the second and third stepped substrates S2 and S3 are coupled to each other, and the third coupled region P3 where the third and fourth stepped substrates S3 and S4 are coupled to each other may be continuously maintained the coupled state therebetween. Also, when the fourth suction device 340_4 vertically ascends, the auxiliary substrate 100 may be more detached from the panel substrate 200 by the fourth vacuum adsorption pad 310_4.

As described above, according to an embodiment of the inventive concept, since the substrate detachment apparatus 300 successively detach the auxiliary substrate 100 from the outermost stepped substrate, the auxiliary substrate 100 may be separated from the panel substrate 200 at a predetermined angle. As a result, a crack phenomenon occurring when the auxiliary substrate 100 is detached from the panel substrate 200 at the same time may be prevented.

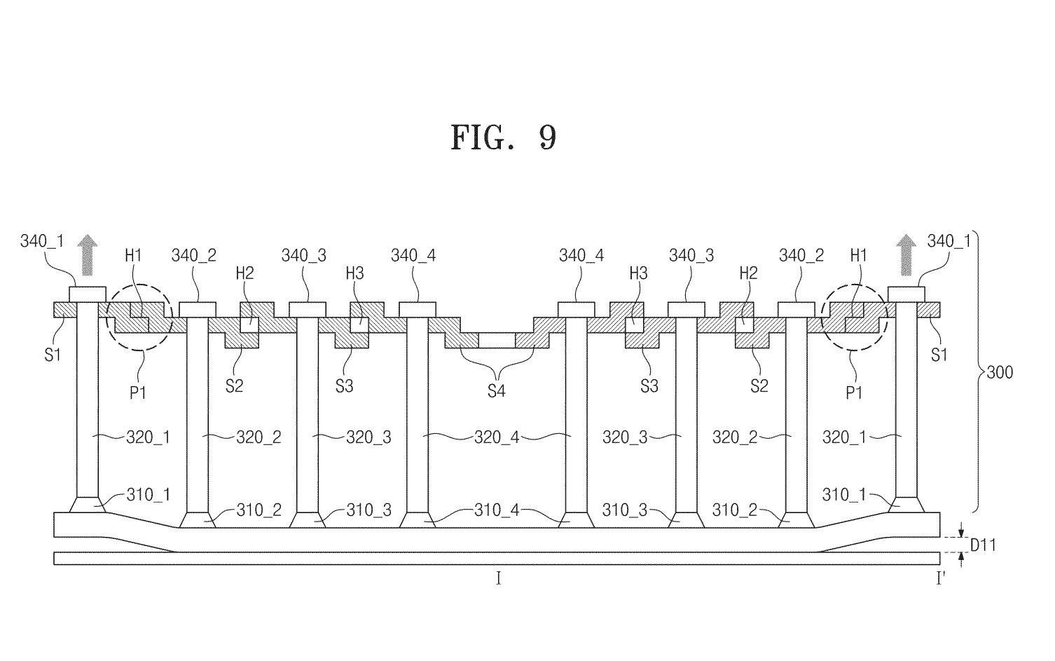

Referring to FIG. 9, FIG. 9 is a cross-sectional view showing a process of detaching the auxiliary substrate from the panel substrate symmetrically on both sides of a center of the substrate detachment apparatus in FIG. 2. In particular, a process of lifting the stepped substrates 330 at one side of a center of the substrate detachment apparatus 300 is symmetrical to a process of lifting the stepped substrates 330 at another side of a center of the substrate detachment apparatus 300. In this way, when the process proceeds until all of the substrates 330 adjacent to the center are lifted, the entire auxiliary substrate 100 is lifted.

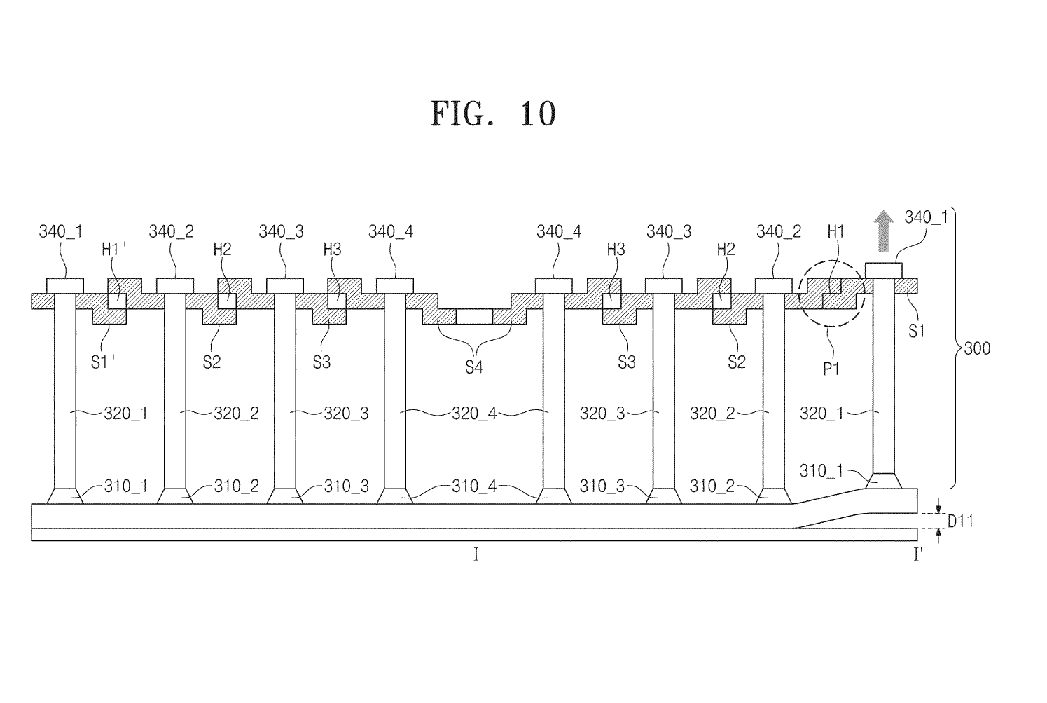

Referring to FIG. 10, FIG. 10 is a cross-sectional view showing a process of detaching the auxiliary substrate from the panel substrate non-symmetrically on both sides of a center of the substrate detachment apparatus in FIG. 2. In particular, a process of lifting the stepped substrates S1 at one side of a center of the substrate detachment apparatus 300 is non-symmetrical to a process of lifting the stepped substrates S1′ at another side of a center of the substrate detachment apparatus 300. In this way, when the substrates S4 at one side adjacent to the center are lifted, the substrates S4 at another side adjacent to the center of the substrate detachment apparatus 300 are not lifted and the entire auxiliary substrate 100 is not completely lifted.

According to the embodiment of the inventive concept, the plurality of stepped substrates having the stair shape are provided. When the plurality of stepped substrates vertically ascend in sequence, the vacuum adsorption pads connected to the stepped substrates may successively separate the auxiliary substrate from the panel substrate. As a result, the auxiliary substrate and the panel substrate may be detached from each other without being damaged. Therefore, the overall processing cost in the manufacturing process of the display apparatus may be reduced.

The present invention has been particularly shown and described with reference to exemplary embodiments thereof While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A substrate detachment apparatus, comprising:
a plurality of stepped substrates having a stair shape, each of which comprises at least one or more stepped layers, the plurality of stepped substrates partially overlapping each other;
a plurality of vacuum generating members coupled to holes formed in each of the stepped substrates; and
a plurality of vacuum adsorption pads connected to the vacuum generating members, the plurality of vacuum adsorption pads being adsorbed to a substrate,
wherein the stepped substrates vertically ascends in sequence inward from a stepped substrate connected to a plurality of vacuum adsorption pads, which are adsorbed to a outermost side of the substrate, of the vacuum adsorption pads.

2. The substrate detachment apparatus of claim 1, further comprising a plurality of suction devices respectively connected to the vacuum generating members to vertically lift the stepped substrates.

3. The substrate detachment apparatus of claim 1, wherein each of the stepped substrates comprises:
a first stepped layer extending in a horizontal direction;
a second stepped layer overlapping one region that is defined above the first stepped layer to form the stair shape together with the first stepped layer; and
a third stepped layer overlapping one region that is defined above the second stepped layer to form the stair shape together with the second stepped layer.

4. The substrate detachment apparatus of claim 3, wherein the holes, to which the vacuum generating members are coupled, are defined in the second stepped layer.

5. The substrate detachment apparatus of claim 3, wherein, in two first and second stepped substrates adjacent to each other of the stepped substrates, one region of the third stepped layer of the first stepped substrate and one region of the first stepped layer of the second stepped substrate overlap each other with a predetermined gap therebetween.

6. The substrate detachment apparatus of claim 5, wherein the second stepped substrate is disposed further outside than the first stepped substrate.

7. The substrate detachment apparatus of claim 5, wherein, after the second stepped substrate vertically ascends, the first stepped substrate vertically ascends.

8. The substrate detachment apparatus of claim 7, wherein, when the second stepped substrate vertically ascends, the first stepped layer of the second stepped substrate is in contact with and coupled to the third stepped layer of the first stepped substrate.

9. The substrate detachment apparatus of claim 3, wherein the second stepped layers of each of the stepped substrates have heights corresponding to positions parallel to each other.

10. The substrate detachment apparatus of claim 3, wherein the second stepped layer has an extension length longer than that of the first or third stepped layer.

11. A method for manufacturing a display apparatus, comprising:
providing an auxiliary substrate and a panel substrate;
attaching the auxiliary substrate to the panel substrate;
performing a process of manufacturing the display panel on the panel substrate; and
separating the auxiliary substrate from the panel substrate,
wherein the separating of the auxiliary substrate comprises:
providing a plurality of stepped substrates having a stair shape, each of which comprises at least one or more stepped layers, and partially overlapping each other,
coupling a plurality of vacuum generating members to holes formed on each of the stepped substrates;
connecting the plurality of vacuum adsorption pads to the vacuum generating members;
adsorbing the vacuum adsorption pads onto the auxiliary substrate; and
vertically lifting the stepped substrates in sequence inward from the stepped substrate coupled to a plurality of vacuum adsorption pads, which are adsorbed to a outermost side of the auxiliary substrate of the vacuum adsorption pads.

12. The method of claim 11, further comprising connecting a plurality of suction devices to the vacuum generating members,
wherein the suction devices vertically lift the stepped substrates in sequence inward from the outermost substrate.

13. The method of claim 11, wherein each of the stepped substrates comprises:
a first stepped layer extending in a horizontal direction;
a second stepped layer overlapping one region that is defined above the first stepped layer to form the stair shape together with the first stepped layer; and
a third stepped layer overlapping one region that is defined above the second stepped layer to form the stair shape together with the second stepped layer.

14. The method of claim 13, wherein, in two adjacent stepped substrates, one region of a third stepped layer of one of the stepped substrates and one region of a first stepped layer of the other one of the stepped substrates overlap each other with a predetermined gap between the first and third layers.

15. The method of claim 14, wherein the second stepped substrate is disposed further outside than the first stepped substrate.

16. The substrate detachment apparatus of claim 1, wherein the stepped layers are parallel to each other.

17. The substrate detachment apparatus of claim 1, wherein each stepped layer has a vertical lateral surface.

18. The substrate detachment apparatus of claim 5, wherein the gap has a rectangular cross-sectional shape.

19. The method of claim 11, wherein the sequence for the stepped substrates at one side of a central region of the auxiliary substrate is non-synchronized with the sequence of stepped substrates at another side of the central region.

20. The method of claim 11, wherein the sequence for the stepped substrates at one side of a central region of the auxiliary substrate is synchronized with the sequence of stepped substrates at another side of the central region.
